(19) United States
(12) Patent Application Publication
(10) Pub. No.: US 2017/0144164 A1
(43) Pub. Date: May 25, 2017

(54) Bladeless Trimmer

(71) Applicant: S&D LLC, Auburn, CA (US)

(72) Inventors: Daniel K. Lovas, Auburn, CA (US); Sean S. Grogan, Auburn, CA (US)

(21) Appl. No.: 15/359,079

(22) Filed: Nov. 22, 2016

Related U.S. Application Data
(60) Provisional application No. 62/259,117, filed on Nov. 24, 2015.

(51) Int. Cl. B02C 17/02; B02C 17/18

(52) U.S. Cl. CPC B02C 17/02; B02C 17/18

(57) ABSTRACT

A bladeless trimmer is used for trimming or harvesting plant and animal matter. The bladeless trimmer includes a tumbling receptacle, a base table, and an axle. The base table includes a support frame and a plurality of legs. The support frame braces the tumbling receptacle, while the plurality of legs elevates the tumbling receptacle so that the tumbling receptacle is free to rotate unimpeded. The tumbling receptacle is used to hold and trim plant or animal matter. The tumbling receptacle includes a first plate, a second plate, and a receptacle net. The first plate and the second plate are mounted onto the axle which rotates on the support frame. Together, the first plate, the second plate, and the receptacle net form an enclosure for holding items. At least one receptacle scraper is mounted to the support frame and is used to aid in trimming items by contacting the receptacle net.

The current application claims a priority to the U.S. Provisional Patent application Ser. No. 62/259,117 filed on Nov. 24, 2015.

### FIELD OF THE INVENTION

The present invention relates generally to machines and appliances for trimming plant or animal matter. More specifically, the present invention is a bladeless trimmer which uses a tumbling receptacle to clean or trim various types of plant or animal matter.

### BACKGROUND OF THE INVENTION

Trimming devices are commonly used for harvesting desired resources from plants or for cleaning off undesired materials from animals. For example, a trimming device may be used to harvest cotton from a cotton plant or to pluck feathers from a chicken. While there are many existing inventions which may be catered to trimming a specific resource, such inventions may be very expensive or limited in versatility. Alternatively, users may opt to trim resources manually. Even with hand tools, manual work can be tiring and time consuming.

Accordingly, there is a present need for a versatile machine or appliance which may be used to clean or trim a wide range of plant or animal matter at an efficient rate. The present invention is a bladeless trimmer which utilizes a tumbling receptacle to trim off unwanted material or harvest desired resources from plants or animals. The tumbling receptacle includes a receptacle net which is used to snag plant and animal matter, separating it from the plant or animal placed within the tumbling receptacle. The bladeless trimmer also makes use of a receptacle scraper which aids in trimming larger plant or animal matter. Throughout the process of trimming, all plant and animal matter that is expelled from the tumbling receptacle is collected in a waste bag for easy disposal or preservation.

### BRIEF DESCRIPTION OF THE DRAWINGS

FIG. 1 is a front left perspective view of the present invention.

FIG. 2 is a front right perspective view of the present invention.

FIG. 3 is a front right perspective view of the present invention with the receptacle net and the waste bag hidden.

FIG. 4 is a front right perspective view of the present invention showing the safety hood.

FIG. 5 is a perspective view of the receptacle net.

FIG. 6 is a schematic diagram showing plurality of polygonal perforations made with the receptacle net.

FIG. 7 is a schematic diagram showing how the motor engages with the axle.

FIG. 8 is a schematic diagram showing the arrangement of the plurality of receptacle scrapers.

### DETAILED DESCRIPTION OF THE INVENTION

All illustrations of the drawings are for the purpose of describing selected versions of the present invention and are not intended to limit the scope of the present invention.

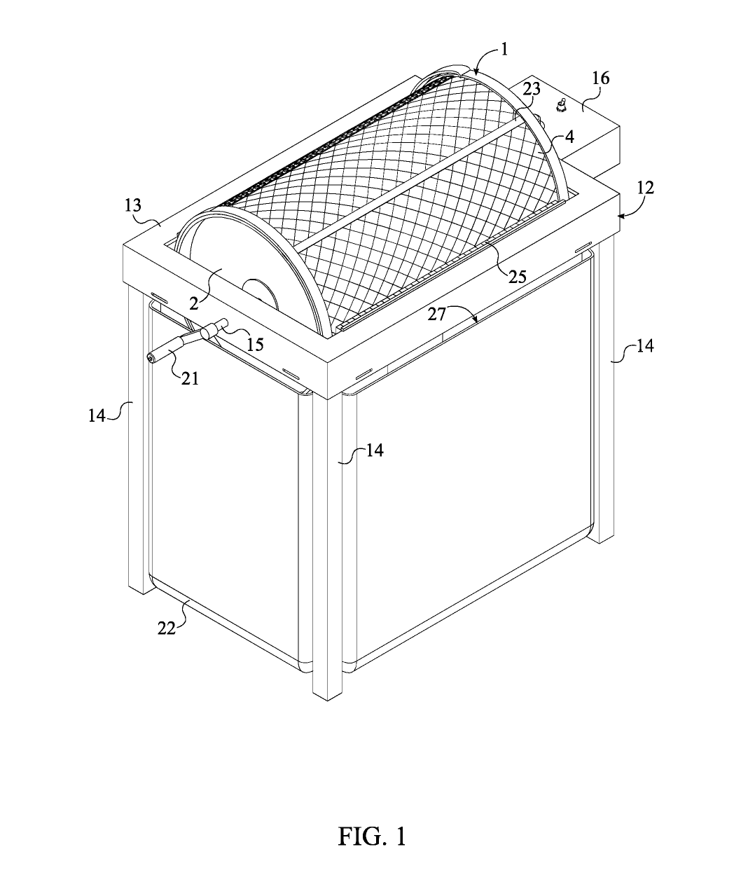

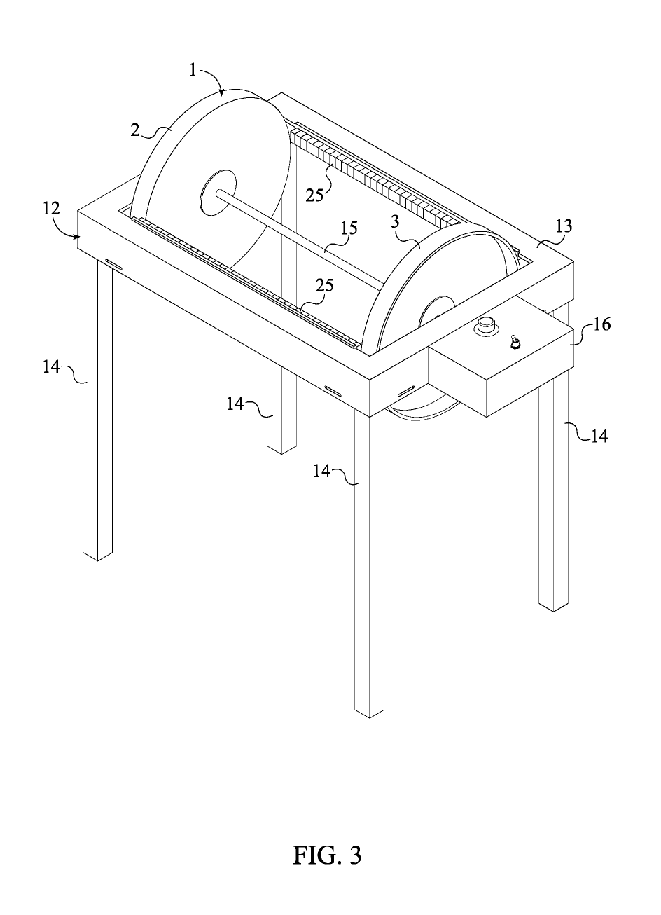

With reference to FIGS. 1-3, the present invention is a bladeless trimmer that may be used for cleaning and trimming plants or animal carcasses. The present invention comprises a tumbling receptacle 1, a base table 12, and an axle 15. The tumbling receptacle 1 is used to hold and trim plant or animal matter. The tumbling receptacle 1 comprises a first plate 2, a second plate 3, and a receptacle net 4. The first plate 2 and the second plate 3 are used to reinforce the receptacle net 4, creating an enclosure capable of holding plant or animal matter. The base table 12 comprises a support frame 13 and a plurality of legs 14. The base table 12 is used to support the tumbling receptacle 1, while also permitting the tumbling receptacle 1 to rotate. The axle 15 centrally traverses through the first plate 2 and the second plate 3. The first plate 2 and the second plate 3 are rotatably mounted to the support frame 13 by the axle 15. This arrangement causes the first plate 2 and the second plate 3 to rotate when the axle 15 is rotated. The receptacle net 4 is perimetrically mounted about the first plate 2. Similarly, the receptacle net 4 is perimetrically mounted about the second plate 3, opposite to the first plate 2. The first plate 2 and the second plate 3 are positioned offset from each other along the axle 15. This arrangement helps to stretch the receptacle net 4 between the first plate 2 and the second plate 3, creating an enclosure to hold plant and animal matter.

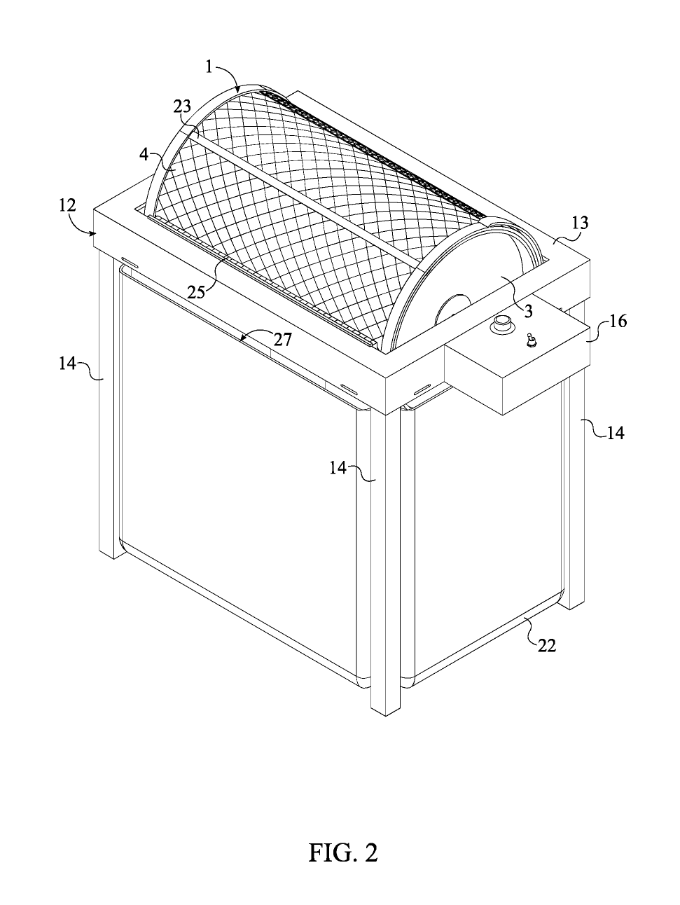

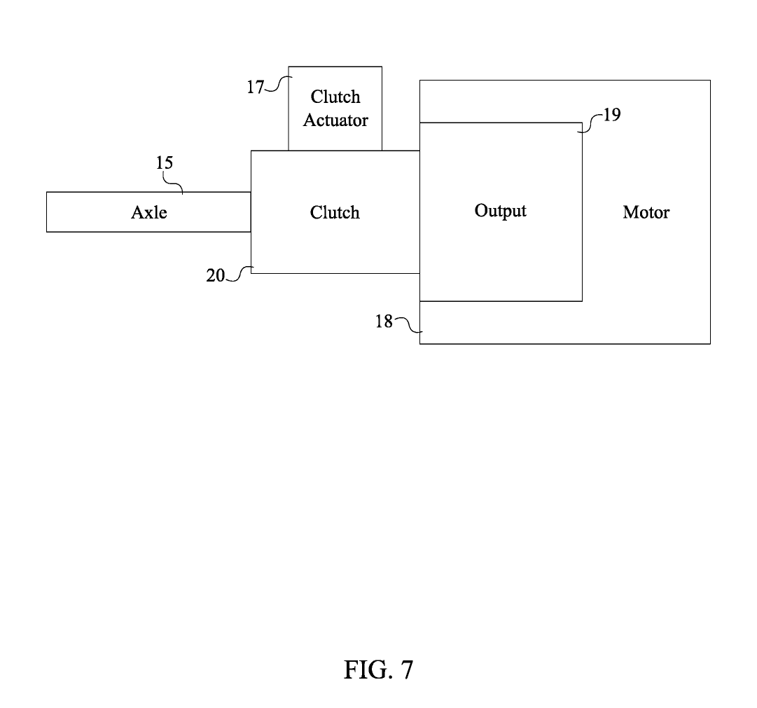

In reference to FIG. 2 and FIG. 7, the present invention further comprises a control unit 16 and a motor 18. The motor 18 is used to rotate the axle 15, which, in turn, rotates the tumbling receptacle 1. The motor 18 is mounted to the support frame 13, adjacent to the axle 15. An output 19 of the motor 18 is torsionally connected to the axle 15. The control unit 16 is mounted onto the support frame 13 and is operatively coupled to the motor 18. This arrangement allows the control unit 16 to actuate the motor 18. Specifically, the control unit 16 is capable of regulating the speed and/or the direction in which the output 19 of the motor 18 rotates. Furthermore, the control unit 16 comprises a power source and a fuse. The power source is electrically connected to the motor 18 and is used to power the motor 18. The power source may be a battery or a standard electrical cord. The fuse is electrically connected in between the power source and the motor 18. The fuse is used to prevent the present invention for damaging itself or injuring the user in the event of a power surge or a malfunction. The fuse is designed to fail in such a situation, thereby cutting power to the motor 18.

In reference to FIG. 7, the present invention further comprises a clutch 20. The clutch 20 is torsionally integrated in between the axle 15 and the output 19 of the motor 18. This arrangement allows the clutch 20 to control whether the motor 18 drives the axle 15. The control unit 16 comprises a clutch actuator 17. The clutch actuator 17 is operatively coupled to the clutch 20. The clutch actuator 17 is used to engage or disengage the clutch 20. In the preferred embodiment of the present invention, the clutch actuator 17 is a bolt which may be tightened or loosened in order to engage or disengage the clutch 20. Alternatively, the clutch actuator 17 may be a switch or a button which actuates the clutch 20 electronically.

In reference to FIG. 1, the preferred embodiment of the present invention further comprises a hand crank 21. The hand crank 21 is torsionally connected to the axle 15 and may be used to rotate the tumbling receptacle 1 instead of the motor 18. The hand crank 21 allows the user to more directly control the rotation of the tumbling receptacle 1. The clutch 20 has the added benefit of allowing the user to disable the motor 18 if the user wishes to use the hand crank 21. When using the motor 18, the hand crank 21 may be removed from the axle 15 so that the hand crank 21 does not rotate while the motor 18 is driving the axle 15.

In reference to FIGS. 1-2, the present invention further comprises a waste bag 22. The waste bag 22 is laterally positioned to the tumbling receptacle 1 and is used to catch trimmings that fall from the tumbling receptacle 1. A rim 27 of the waste bag 22 is perimetrically attached about the support frame 13. In the preferred embodiment of the present invention, the tumbling receptacle 1 is positioned into the waste bag 22. This arrangement helps to ensure that none of the trimmings that fall from the tumbling receptacle 1 escape the waste bag 22.

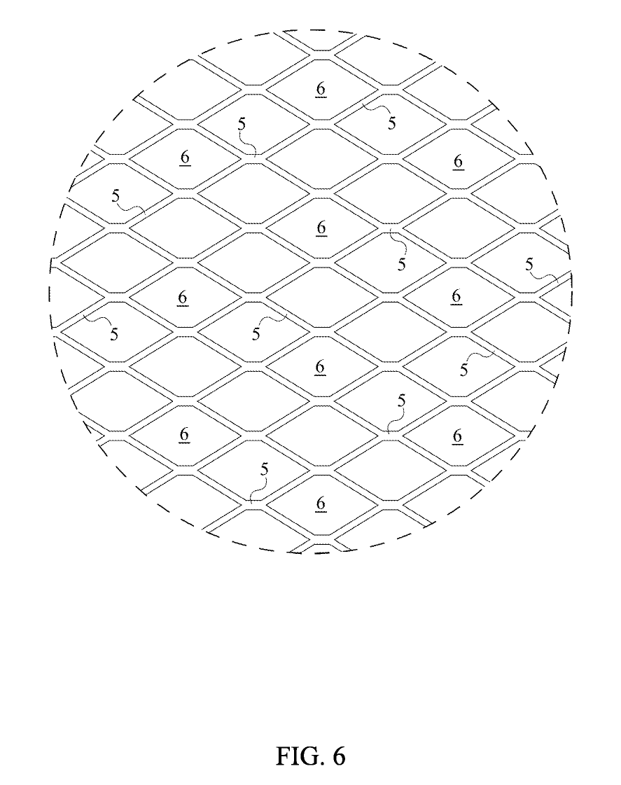

In reference to FIG. 6, the receptacle net 4 is a plurality of net linings 5. The plurality of net linings 5 is woven to form a plurality of polygonal net perforations 6. Each of the plurality of polygonal net perforations 6 is polygonal in shape in order to facilitate the trimming of plant an animal matter. The shape of each polygonal net perforation 6 may be a triangular, quadrilateral, pentagonal, or hexagonal in shape. Further, shapes including a greater number of sides may alternatively be used. All polygonal shapes have a plurality of corners. The corners of the polygonal net perforations 6 help to snag branches, twigs, feathers, or any other type of plant or animal matter which may need to be trimmed. The receptacle net 4 may be made from various different materials depending on the needs of the user. Such materials can include plastic, metal, and cloth. The plurality of net linings 5 may be arranged to form large or small polygonal net perforations 6. With smaller polygonal net perforations 6, such as in a mesh screen, the receptacle net 4 may be used as a pollinator. Alternatively, with larger polygonal perforations 6, the receptacle net 4 may be used to break up dense plants.

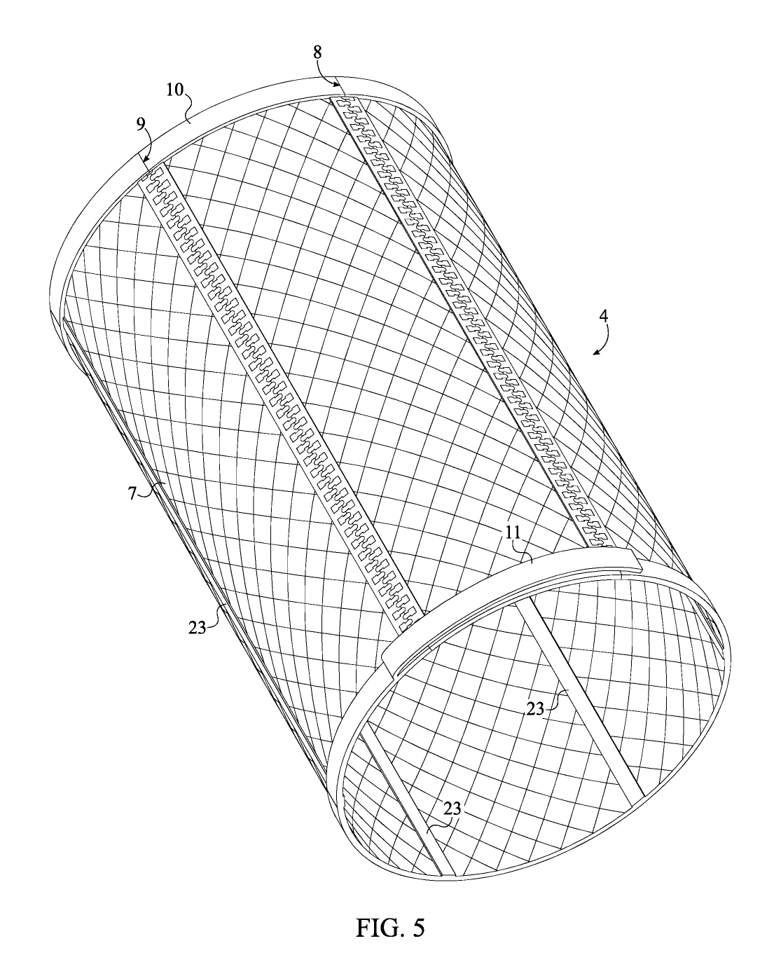

In reference to FIG. 5, the receptacle net 4 comprises an enclosing portion 7 and a flap portion 10. Together, the enclosing portion 7 and the flap portion 10 are used to hold items within the tumbling receptacle 1. The enclosing portion 7 comprises a first edge 8 and a second edge 9 which are positioned opposite to each other across the enclosing portion 7. The enclosing portion 7 is secured around the first plate 2 and the second plate 3 from the first edge 8 to the second edge 9. The width of the enclosing portion 7 is sized to be smaller than the perimeters of the first plate 2 and the second plate 3. This arrangement creates a gap along the perimeters of the first plate 2 and the second plate 3 which may be covered by the flap portion 10. The first edge 8 is attached adjacent to the flap portion 10. The second edge 9 is attached adjacent to the flap portion 10, opposite to the first edge 8. In this arrangement, the flap portion 10 may be detached to place items into the tumbling receptacle 1 or take items out of the tumbling receptacle 1. Conversely, the flap portion 10 may be fully attached along the enclosing portion 7 in order to secure items within the tumbling receptacle 1. In the preferred embodiment of the present invention, the flap portion 10 is secured to the enclosing portion 7 using zipper fasteners; however, any other means of fastening the flap portion 10 to the enclosing portion 7 may be used.

In reference to FIG. 5, the receptacle net 4 comprises a flap cover 11. The flap cover 11 is used to secure the flap portion 10 onto the enclosing portion 7 in order to prevent the flap portion 10 from detaching from the enclosing portion 7. The flap cover 11 is hingedly connected to the first edge 8 and is removably attached to the second edge 9. In the preferred embodiment of the present invention, the flap cover 11 is secured to the second edge 9 using hook and loop fasteners; however various other fasteners may alternatively be used.

In reference to FIG. 5, the present invention further comprises a plurality of reinforcing members 23. The plurality of reinforcing members 23 is used give strength to the receptacle net 4 and prevent the receptacle net 4 from sagging. The plurality of reinforcing members 23 is laterally connected to the receptacle net 4 and is distributed across the receptacle net 23. This arrangement provides equal support to the receptacle net 4 between the first plate 2 and the second plate 3.

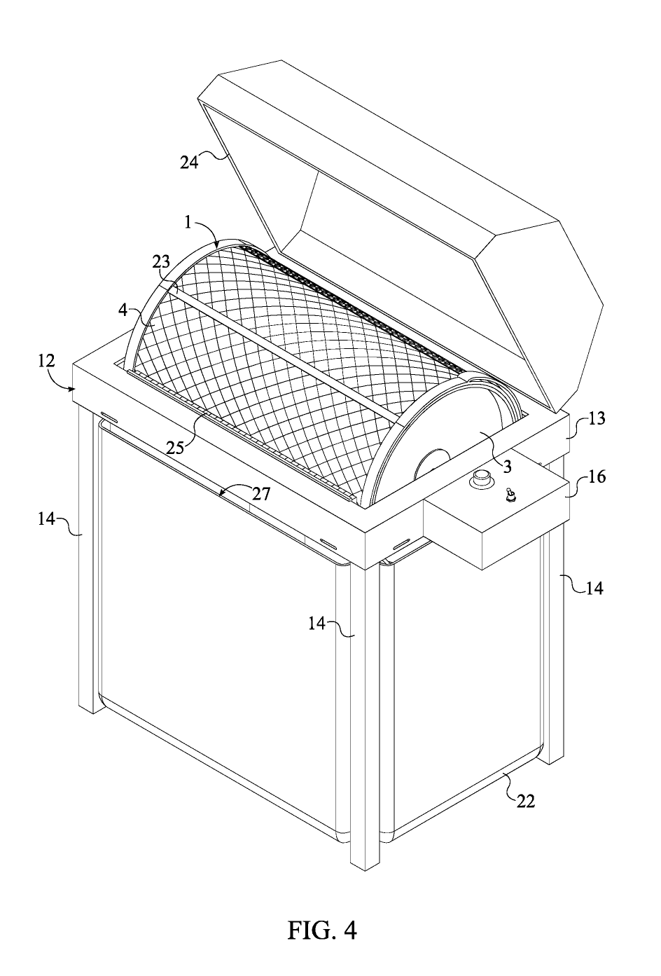

In reference to FIG. 4, the present invention further comprises a safety hood 24. The safety hood 24 is hingedly connected to the support frame 13, opposite to the plurality of legs 14 and is used to protect the user from any trimmings or debris which may be expelled from the tumbling receptacle 1. The safety hood 24 is laterally positioned about the tumbling receptacle 1 such that no debris may be thrown upwards or outwards from the tumbling receptacle 1. Instead, any debris that is expelled from the tumbling receptacle 1 is directed downwards and into the waste bag 22.

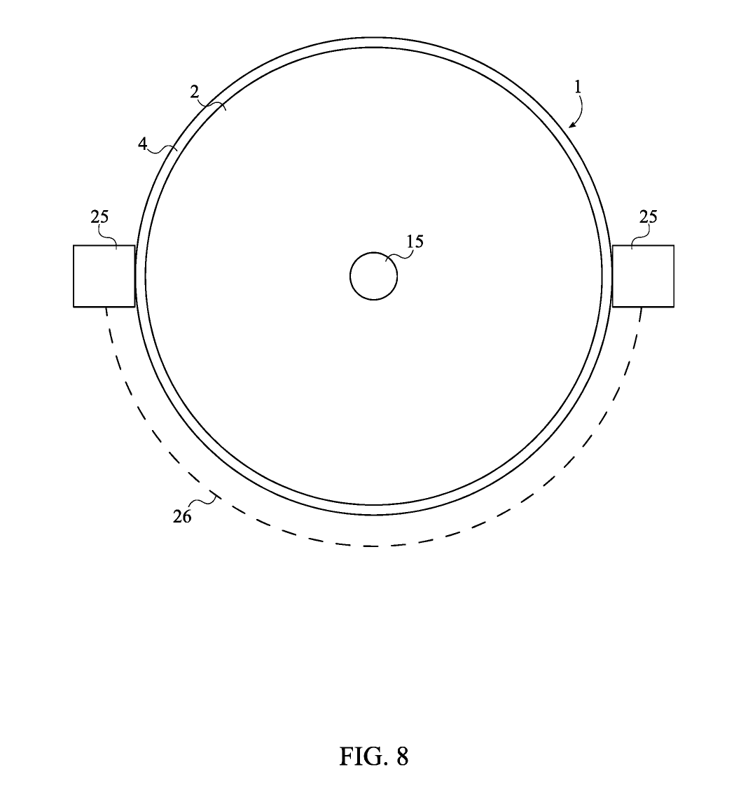

In reference to FIGS. 2-3 and FIG. 8, the present invention further comprises at least one receptacle scraper 25. The receptacle scraper 25 is used to trim larger items such as leaves or sticks. The receptacle scraper 25 is mounted onto the support frame 13 and is laterally positioned along the tumbling receptacle 1. This arrangement allows the receptacle scraper 25 to break off plant or animal matter that protrudes from the tumbling receptacle 1. In the preferred embodiment of the present invention, the at least one receptacle scraper 25 is a plurality of receptacle scrapers 25 which is distributed along a specified circular arc 26 about the tumbling receptacle 1. With more than one receptacle scraper 25, the present invention is able to trim plant or animal matter faster than with just one receptacle scraper 25 alone. In the preferred embodiment of the present invention, the receptacle scraper 25 is a brush. The use of a brush as the receptacle scraper 25 is beneficial to the utility of the present invention because the bristles of the brush are able to deform to the shape of the receptacle net 4 which may lumpy or otherwise non-uniform due to the material enclosed within the receptacle net 4.

Although the invention has been explained in relation to its preferred embodiment, it is to be understood that many other possible modifications and variations can be made without departing from the spirit and scope of the invention as hereinafter claimed.

What is claimed is:

1. A bladeless trimmer comprises:
a tumbling receptacle;
a base table;
an axle;
the tumbling receptacle comprises a first plate, a second plate, and a receptacle net;
the base table comprises a support frame and a plurality of legs;
the axle centrally traversing through the first plate and the second plate;
the first plate and the second plate being positioned offset from each other along the axle;
the first plate and the second plate being rotatably mounted to the support frame by the axle;
the receptacle net being perimetrically mounted about the first plate; and
the receptacle net being perimetrically mounted about the second plate, opposite to the first plate.

2. The bladeless trimmer as claimed in claim 1 comprises:
a control unit;
a motor;
the motor being mounted to the support frame, adjacent to the axle;
an output of the motor being torsionally connected to the axle;
the control unit being mounted onto the support frame; and
the control unit being operatively coupled to the motor, wherein the control unit is used to actuate the motor.

3. The bladeless trimmer as claimed in claim 2 comprises:
a clutch;
the control unit comprises a clutch actuator;
the clutch being torsionally integrated in between the axle and the output of the motor; and
the clutch actuator being operatively coupled to the clutch, wherein the clutch actuator is used to engage or disengage the clutch.

4. The bladeless trimmer as claimed in claim 1 comprises:
a hand crank; and
the hand crank being torsionally connected to the axle.

5. The bladeless trimmer as claimed in claim 1 comprises:
a waste bag;
the waste bag being laterally positioned to the tumbling receptacle; and
a rim of the waste bag being perimetrically attached about the support frame.

6. The bladeless trimmer as claimed in claim 1 comprises:
the receptacle net being a plurality of net linings; and
the plurality of net linings being woven to form a plurality of polygonal net perforations.

7. The bladeless trimmer as claimed in claim 1 comprises:
the receptacle net comprises an enclosing portion and a flap portion;
the enclosing portion comprises a first edge and a second edge;
the first edge and the second edge being positioned opposite to each other across the enclosing portion;
the first edge being attached adjacent to the flap portion; and
the second edge being attached adjacent to the flap portion, opposite to the first edge.

8. The bladeless trimmer as claimed in claim 7 comprises:
the receptacle net comprises a flap cover;
the flap cover being hingedly connected to the first edge; and
the flap cover being removably attached to the second edge.

9. The bladeless trimmer as claimed in claim 1 comprises:
a plurality of reinforcing members;
the plurality of reinforcing members being laterally connected to the receptacle net; and
the plurality of reinforcing members being distributed across the receptacle net.

10. The bladeless trimmer as claimed in claim 1 comprises:
a safety hood;
the safety hood being hingedly connected to the support frame, opposite to the plurality of legs; and
the safety hood being laterally positioned about the tumbling receptacle.

11. The bladeless trimmer as claimed in claim 1 comprises:
at least one receptacle scraper;
the receptacle scraper being mounted onto the support frame; and
the receptacle scraper being laterally positioned along the tumbling receptacle.

12. The bladeless trimmer as claimed in claim 10 comprises:
the at least on receptacle scraper being a plurality of receptacle scrapers; and
the plurality of receptacle scrapers being distributed along a specified circular arc about the tumbling receptacle.

13. The bladeless trimmer as claimed in claim 10 comprises:
the receptacle scraper being a brush.
